(19) United States
(12) Patent Application Publication
(10) Pub. No.: US 2023/0174881 A1
(43) Pub. Date: Jun. 8, 2023

(54) PREPARATION METHOD OF MULTIFUNCTIONAL MODIFIED MOLYBDENUM DISULFIDE NANO-ADDITIVE ADDED TO CUTTING FLUID

(71) Applicants: Shanghai Maritime University, Shanghai (CN); Shanghai Greenstec E&P Co.,LTD, Shanghai (CN)

(72) Inventors: Yaohua Dong, Shanghai (CN); Hongling Zhu, Shanghai (CN); Lihua Dong, Shanghai (CN); Jingjing Wei, Shanghai (CN); Zhenyuan Chen, Shanghai (CN); Mingmou Han, Shanghai (CN)

(21) Appl. No.: 18/062,016

(22) Filed: Dec. 5, 2022

(30) Foreign Application Priority Data
Dec. 7, 2021 (CN) 202111482836.6

(51) Int. Cl. C10M 125/22; B82Y 40/00

(52) U.S. Cl. CPC C10M 125/22; B82Y 40/00; C10M 2201/066

(57) ABSTRACT

The invention relates to a preparation method for a multifunctional modified molybdenum disulfide nano-additive, with step 1: synthesizing a lignocellulose; step 2: synthesizing lignocellulose/MoS₂ composite nanoparticles; step 3: synthesizing a lignocellulose/MoS₂—Ag nanocomposite to obtain the multifunctional modified molybdenum disulfide nano-additive. The invention provides a preparation method for a multifunctional modified molybdenum disulfide nano-additive, adding which into the cutting fluid will remarkably improve the lubricating property, bactericidal and corrosion resistance performance.

### CROSS-REFERENCE TO RELATED APPLICATIONS

This application claims the benefit and priority of Chinese Patent Application Number 202111482836.6, filed on Dec. 7, 2021, the disclosures of which are incorporated herein by reference in their entireties.

### TECHNICAL FIELD

The present disclosure relates to the technical field of additives, and in particular to a preparation method for a multifunctional modified molybdenum disulfide nano-additive.

### BACKGROUND

With the development of high-speed machining techniques and high-performance material, in order to obtain a workpiece with high precision surface and quality conformance, the usage of cutting fluid in the machining process has been increasing. Higher requirement for lubricity, cooling performance and corrosion resistance of cutting fluid is raised. Because of the high calorific value during the process of high-speed cutting, the poor heat dissipation effect of oil-based cutting liquid may increase the temperature of the cutting area, causing smoke and fire or other accidents. In addition, the cooling performance of cutting oil is poor, and it is more likely to occur thermal distortion of the workpiece because of high temperature, thus affecting the machining precision of the workpiece; thus water-based cutting fluid is used in the field recently.

Water-based cutting fluid has good cooling and corrosion resistance performance in comparison with oil-based cutting fluid, so that it is the most widely used cutting fluid in the metal machining industry. However, since the lubricant content contained therein is low, during the machining process, the cutting tool cannot get sufficient boundary lubrication so that the problems of unstable machining, serious wear of the cutting tool and the like usually occur in the process. Furthermore, the diluted cutting fluid contains a large number of hydrocarbons, sulfur and nitrogen compounds, water and the like, which allows the cutting fluid becoming an advantageous environment for the microorganism growth and reproduction, resulting in acidification, blackening and odor of cutting fluid. At present, methods for controlling microorganisms in cutting fluid mainly include the addition of bacteriostatic agents, ultraviolet sterilization, ozone sterilization and so on. But most of the bacteriostatic agents are formaldehyde-based agents, which easily form aerosol that may be directly inhaled into the body of a worker, causing serious health threat to the respiratory tract, and even the carcinogenic danger. The light transmittance of ultraviolet light is low, which will seriously affect its sterilizing efficiency. Ozone has a strong oxidizing property, which will easily cause serious corrosion to equipment or serious physical damage to workers.

Therefore, the question on how to keep the balance between the performance in lubricity and cooling and the effective control of the number of microorganisms in the cutting fluid is a technical bottleneck which needs to be broken through urgently at present.

### SUMMARY

In order to overcome the limitations in the prior art, the present disclosure provides a preparation method for a multifunctional modified molybdenum disulfide nano-additive.

The technical solution for realizing the objective of the present disclosure is as follows:

a preparation method for a multifunctional modified molybdenum disulfide nano-additive, comprises steps of:

Step 1: synthesizing a lignocellulose;

Step 2: synthesizing lignocellulose/MoS₂ composite nanoparticles;

Step 3: synthesizing a lignocellulose/MoS₂—Ag nanocomposite to obtain a multifunctional modified molybdenum disulfide nano-additive.

In a further embodiment, the step 2 specifically comprises:

Adding a sodium molybdate and a thiourea into deionized water, mixing uniformly to get a uniform and transparent molybdenum precursor solution; adding a lignocellulose into deionized water and stirring uniformly to obtain a lignocellulose aqueous solution, slowly adding the lignocellulose aqueous solution into the molybdenum precursor solution to obtain a first mixed solution, continuously stirring until the first mixed solution becoming sol-emulsion, transferring the first mixed solution to a reactor, carrying out the reaction at a predetermined temperature for a predetermined time to yield a product, and then filtering and washing the product after the reactor is cooled, filtering a black substance from the product, drying the black substance in a vacuum oven to obtain black nanoparticles, gently grinding the black nanoparticles until there is no hard lump to obtain the lignocellulose/MoS₂ composite nanoparticles as solid powder.

In a further embodiment, the step 2 specifically comprises:

Adding 2 mmol sodium molybdate and 10 mmol thiourea into 40 ml deionized water, ultrasonically mixing uniformly to obtain an uniform, transparent molybdenum precursor solution; adding 0.5 g lignocellulose into 6 ml deionized water, stirring uniformly to obtain the lignocellulose aqueous solution, slowly adding the lignocellulose aqueous solution into the molybdenum precursor solution to obtain the first mixed solution, continuously stirring the first mixed solution until becoming sol-emulsion, transferring the first mixed solution to a stainless steel lined high-temperature and high-pressure double-station parallel reactor, carrying out the reaction at 200° C. for 24 hours to yield the product, and then filtering and washing the product with deionized water and ethanol repeatedly after the reactor is naturally cooled to room temperature, filtering the black substance from the product, drying the black substance in a vacuum oven at 60° C. for 24 hours to obtain black nanoparticles, grinding the black nanoparticles until there is no hard lump to obtain the lignocellulose/MoS₂ composite nanoparticles as solid powder.

In a further embodiment, the step 3 specifically comprises:

Dissolving lignocellulose/MoS₂ composite nanoparticles, a casein hydrolysate and a sodium hydroxide in deionized water with stirring, adding a silver nitrate solution dropwise to obtain a second mixed solution, stirring the second mixed solution at a predetermined temperature for a predetermined time, then mixing with alcohol and centrifuging with high speed to yield a precipitate, lastly, after washing the precipitate and drying under vacuum to obtain the lignocellulose/MoS₂—Ag nanocomposite, namely the multifunctional modified molybdenum disulfide nano-additive.

In a further embodiment, the step 3 specifically comprises:

Dissolving 20 g lignocellulose/MoS₂ nanocomposite particles, 25 mg casein hydrolysate and 10 mg sodium hydroxide in 45 ml deionized water with vigorous stirring, adding 5 ml silver nitrate solution dropwise to obtain a second mixed solution, magnetically stirring the second mixed solution at 60° C. for 3 h, then mixing with an alcohol at 1:4 and centrifuging with high speed at 20000 rmp to yield precipitate, lastly, after washing the precipitate with deionized water, drying under vacuum to obtain the lignocellulose/MoS₂—Ag nanocomposite, namely the multifunctional modified molybdenum disulfide nano-additive.

In a further embodiment, the step 1 specifically comprises:

Step 1.1: placing a baked wood sample in a vacuum flask covered with a diaphragm, then adding a BiBB solution to the flask slowly with a syringe, and adding a glucopyranose to obtain a reaction system, stirring the reaction system at room temperature for a predetermined time, taking out the wood sample and blotting with paper, washing the wood sample with acetone three times to obtain the functional wood (W-Br), drying the obtained functional wood (W-Br) at 65° C. for 24 hours under vacuum, and reacting the dried functional wood (W-Br) in THF/Et3N (tetrahydrofuran/triethylamine) and pyridine solution, respectively;

Step 1.2: using the reacted functional wood (W-Br) as an ATRP macroinitiator for in-situ polymerization, performing a catalytic reaction of styrene (St) and N-isopropyl acrylamide (NIPAM) as monomers, with copper-based complexes pentamethyldiethylenetriamine (PMDETA) as catalyst, setting ATRP ratio to 50:1:1:3 based on the catalytic reaction, placing the reacted functional wood (W-Br) in a first Schlenk flask equipped with a gas inlet and a septum, introducing CuBr, the reacted functional wood (W-Br), styrene (St), N-Isopropyl Acrylamide (NIPAM), copper-based complexes pentamethyldiethylenetriamine (PMDETA) and a solvent in a second Schlenk flask to get a third mixed solution, then degassing the third mixed solution, transferring the third mixed solution after the complete degassing to the first Schlenk flask containing the reacted functional wood (W-Br), heating the first Schlenk flask to 65° C. to perform a polymerization under a tight nitrogen atmosphere for a given time, after the polymerization, ventilating the first Schlenk flask, and taking out the functional wood (W-Br) and washing with acetone or ethanol, or water to obtain a W-polymer sample, lastly, drying the W-polymer sample under vacuum for 24 hours to obtain the lignocellulose.

In a further embodiment, in the step 1.1, the dosage of the BiBB solution is 0.5 mol and the glucopyranose is 162 g/mol.

In a further embodiment, the method for degassing the third mixed solution in the step 1.2 is as follows:

Performing a cyclic degassing of the mixed solution by using a method of a fluid nitrogen cryopreservation, a vacuum-pumping, and a thawing with nitrogen, carrying out the cyclic degassing three times.

The present disclosure provides a multifunctional modified molybdenum disulfide nano-additive, wherein the additive is prepared by using the above-mentioned method.

The present disclosure provides a cutting liquid, wherein the cutting liquid comprises the above-mentioned multifunctional modified molybdenum disulfide nano-additive.

Compared with the prior art, the present disclosure has the significant advantages of:

The present disclosure provides a preparation method for a multifunctional modified molybdenum disulfide nano-additive, by adding which in the cutting fluid, the lubricating, the sterilizing performance, and the corrosion resistance performance can be remarkably improved.

### DETAILED DESCRIPTION OF THE EMBODIMENT

Specific embodiments of the present disclosure are described further below.

A preparation method for a multifunctional modified molybdenum disulfide nano-additive comprises following steps:

1. Synthesis of the Lignocellulose

Firstly, the baked wood sample is placed in a vacuum flask covered with a diaphragm. Then an alpha-bromoisobutyl bromide (BiBB) solution is added to a flask slowly with a syringe, before a glucopyranose is added. The dosage of the BiBB solution is 0.5 mol and the glucopyranose is 162 g/mol. The reaction system is stirred at room temperature for a predetermined time. The wood sample is taken out and blot with paper, and then washed with acetone to remove unreacted substances, the washing is repeated three times to obtain the functional wood (W-Br). The obtained functional wood (W-Br) is dried at 65° C. for 24 hours under vacuum. The dried functional wood (W-Br) reacts in THF/Et3N (tetrahydrofuran/triethylamine) and pyridine solution, respectively;

secondly, the reacted functional wood (W-Br) is used as ATRP macroinitiator for in-situ polymerization. The catalytic reaction of styrene (St) and N-isopropyl acrylamide (NIPAM) as monomers, with copper-based complexes pentamethyldiethylenetriamine (PMDETA) as catalyst is performed. The ATRP ratio is set to 50:1:1:3 based on the catalytic reaction. The reacted functional wood (W-Br) is placed in the first Schlenk flask equipped with a gas inlet and a septum. A mixture of CuBr, the reacted functional wood W-Br, styrene St, N-Isopropyl Acrylamide (NIPAM), copper-based complexes pentamethyldiethylenetriamine (PMDETA) and a solvent is introduced in another separate second Schlenk flask to get a mixed solution. The mixed solution is degassed. The specific degassing method was: performing a cyclic degassing of the mixed solution by using a method of a fluid nitrogen cryopreservation, a vacuum-pumping, and a thawing with nitrogen, the cyclic degassing is carried out three times. The mixed solution after the complete degassing is transferred to the first Schlenk flask containing the reacted functional wood (W-Br), the first Schlenk flask is heated to 65° C. to perform the polymerization under a tight nitrogen atmosphere for a given time. After the polymerization, the first Schlenk flask is ventilated, and the functional wood (W-Br) is taken out and washed with acetone (or ethanol, or water) to obtain the W-polymer sample. Finally, the W-polymer sample is dried under vacuum for 24 hours to obtain the lignocellulose. During the preparation process, the hydroxyl functional groups of the natural components of the wood are esterified, the brominated compound adhered to the wood generated a solid initiator for atom transfer radical polymerization (ATRP), and the amount of halide compound adhered to the wood can be adjusted depending on the reaction time, concentration, stoichiometry, and the ability of the solvent to expand the wood structures.

2. Synthesis of the Lignocellulose/MoS₂ Composite Nanoparticles

The preparation of the lignocellulose/MoS₂ composite nanoparticles and the nanosized MoS₂ comprises the following steps: firstly, 2 mmol sodium molybdate and 10 mmol thiourea are added into 40 ml deionized water, and the mixture is ultrasonically mixed uniformly to obtain an uniform, transparent molybdenum precursor solution; 0.5 g lignocellulose is added into 6 ml deionized water, and the mixture is stirred uniformly to obtain a lignocellulose aqueous solution, then the lignocellulose aqueous solution is added slowly into the molybdenum precursor solution. The mixed solution is continuously stirred until becoming sol-emulsion, and then is transferred to a stainless steel lined high-temperature and high-pressure double-station parallel reactor, the reaction is carried out at 200° C. for 24 hours to yield a product. The product is filtered and washed with deionized water and ethanol repeatedly after the high-pressure reactor naturally cooled to room temperature. A black substance is filtered from the product, and the black substance is dried in a vacuum oven at 60° C. for 24 hours to obtain black nanoparticles; the black nanoparticles are ground gently until there is no hard lump to obtain the lignocellulose/MoS₂ composite nanoparticles as solid powder.

3. Synthesis of the Lignocellulose/MoS₂—Ag Nanocomposite

In order to synthesize the lignocellulose/MoS₂ nanocomposite modified by Ag nanoparticles, a mixture of 20 g lignocellulose/MoS₂ nanocomposite particles, 25 mg casein hydrolysate and 10 mg sodium hydroxide are dissolved in 45 ml deionized water with vigorous stirring, 5 ml silver nitrate solution is then added dropwise to obtain a mixed solution. The mixed solution is magnetically stirred at 60° C. for 3 h, then mixed with alcohol at 1:4 and is centrifuged with high speed at 20000 rmp to yield a precipitate; lastly, after the precipitate is washed with deionized water, and dried under vacuum, the lignocellulose/MoS₂—Ag nanocomposite, namely the multifunctional modified molybdenum disulfide nano-additive is obtained. The nanoparticles with the noble metal will be deposited on the MoS₂ nanosheets in the presence of dispersant after being reduced by the used reducing agent or MoS₂ as the reducing agent through a chemical reaction in the solution. The nanocomposite has advantages of low cost, and high performance of material.

The lubricating performance of the molybdenum disulfide multifunctional nano-additive is realized through two ways: firstly, MoS₂ is a transition metal disulfide, which has a strong interlayer acting force, while between layers, there is a weak binding force as Van der Waals force, so that interlayer slippage is easy to occur, leading to a good lubricating performance of the MoS₂. Secondly, MoS₂ is a graphite-like layered structure, which has a small interlayer acting force. The interlayer spacing of the MoS₂ can be increased by introducing the spherical metal heteroatom into the interlayer of the MoS₂, and the interlayer acting force can be effectively reduced by increasing the interlayer spacing, so that the MoS₂ is easier to generate interlayer slippage. Furthermore, rolling slippage of the spherical metal heteroatom occurs on the interlayers and the surface of a friction pair. The addition of the interlayer slippage and the rolling slippage greatly improves the tribological performance of the MoS₂.

The sterilization performance of the molybdenum disulfide multifunctional nano-additive is realized through two ways: firstly, MoS₂ has good photocatalysis performance, which can excite electrons in the valence band of the molybdenum disulfide in the cutting fluid to transition under natural light condition, so as to generate electron/hole pairs, generate hydroxyl free radical with strong oxidizing property, thus destroying cell walls or cell membranes of microorganism, and completely inactivating microorganism in the cutting fluid. Secondly, the nanosized silver itself has strong inhibition and killing effects on microorganisms, and it does not have drug resistance, making it a good bactericidal material.

The corrosion resistance performance of the molybdenum disulfide multifunctional nano-additive is realized by using lignocellulose: the cellulose has a large molecular weight, and there are many carbonyl groups and hydroxyl groups connected to the framework, and it is easy to cover on the metal surface. There are also various adsorption sites, which can exchange electrons with metal ions to form a compound, and the compound can stably exist in an acidic environment so as to play a role in corrosion resistance.

Comparative Test and Results

1. Lubricating Performance

The cutting fluid added with the multifunctional modified molybdenum disulfide nano-additive (0.2 wt % of lignocellulose/MoS₂—Ag nanocomposite) and the control cutting fluid are tested by using Germany Microtap TTT thread machining torque test system to characterize the lubricating performance of the cutting fluid added with molybdenum disulfide multifunctional nano-additive. It shows that the tapping torque value of the control group is 124 N·cm, while the tapping torque value of the cutting fluid added with the 0.2 wt % molybdenum disulfide multifunctional nano-additive is 98 N·cm. The lower the tapping torque value is, the higher the lubricating performance of the system is. The overall tapping torque efficiency is improved by 20.9%.

2. Bactericidal Performance

A multifunctional molybdenum disulfide nano-additive (0.2 wt %) is added into the stock solution of the cutting fluid without bacteriostatic agent, and is diluted with water at 5%, pseudomonas with the same concentration are added into the cutting fluid and shaking uniformly. The cutting fluid without adding the multifunctional molybdenum disulfide nano-additive is set as the control group. Samples are collected at 0 h, 6 h, 12 h, 24 h, 48 h, and 72 h. Samples are coated on LB broth medium, and placed in a biochemical incubator at 37° C. for 48 h. The plate counting method is used to calculate the bacterial quantity at each time point to characterize the microbial inactivation effect of the cutting fluid with or without the additive under natural illumination. The results show that the bactericidal rate of the cutting fluid with the multifunctional molybdenum disulfide nano-additive reaches 92.2% after 24 h.

3. Corrosion Resistance Performance

The test pieces are prepared according to the requirements of Standard GB/T 6144-2010 in the experiment. The aluminum alloy is used, and the corrosion resistance performance of the cutting fluid is tested according to the experimental method in the standard. Firstly, the control group of the cutting fluid without adding the multifunctional molybdenum disulfide nano-additive and the experimental group added with the multifunctional molybdenum disulfide nano-additive (0.2 wt %) are added into two beakers, the prepared test pieces are immersed in the liquid. Each beaker is covered with a glass cover, and kept in a constant-temperature oven at about 55° C. for 12 h. Then the test pieces are taken out, and observed with naked eyes on the surface color. It shows that the surface of the aluminum alloy in the cutting fluid added with 0.2 wt % of the multifunctional molybdenum disulfide nano-addictive is rust-free, and the surface is almost new which could be regarded as A grade. However, the aluminum alloy surface in the cutting fluid without any additive is slightly darkened to B grade.

The basic principles, principal features, and advantages of the present invention are shown and described above. Those skilled in the art will appreciate that the present invention is not limited by the embodiments described above, the foregoing examples and description illustrate only the principles of the invention, and various changes and modifications are possible without departing from the spirit and scope of the invention, which falls within the scope of the claimed invention as defined by the equivalents of the appended claim.

1. A preparation method for a multifunctional modified molybdenum disulfide nano-additive, characterized in that, comprising following steps:
step 1: synthesizing a lignocellulose, specifically comprising: step 1.1: placing a baked wood sample in a vacuum flask covered with a diaphragm, then adding a BiBB solution to the flask slowly with a syringe, and adding a glucopyranose to obtain a reaction system, stirring the reaction system at room temperature for a predetermined time, taking out the wood sample and blotting with paper, washing the wood sample with acetone three times to obtain the functional wood W-Br, drying the obtained functional wood W-Br at 65° C. for 24 hours under vacuum, and reacting the dried functional wood W-Br in THF/Et3N tetrahydrofuran/triethylamine and pyridine solution, respectively; step 1.2: using the reacted functional wood W-Br as an ATRP macroinitiator for in-situ polymerization, performing a catalytic reaction of styrene St and N-isopropyl acrylamide NIPAM as monomers, with copper-based complexes pentamethyldiethylenetriamine PMDETA as catalyst, setting ATRP ratio to 50:1:1:3 based on the catalytic reaction, placing the reacted functional wood W-Br in a first Schlenk flask equipped with a gas inlet and a septum, introducing CuBr, the reacted functional wood W-Br, styrene St, N-Isopropyl Acrylamide NIPAM, copper-based complexes pentamethyldiethylenetriamine PMDETA and a solvent in a second Schlenk flask to get a third mixed solution, then degassing the third mixed solution, transferring the third mixed solution after the complete degassing to the first Schlenk flask containing the reacted functional wood W-Br, heating the first Schlenk flask to 65° C. to perform a polymerization under a tight nitrogen atmosphere for a given time, after the polymerization, ventilating the first Schlenk flask, and taking out the functional wood W-Br and washing with acetone or ethanol, or water to obtain a W-polymer sample, lastly, drying the W-polymer sample under vacuum for 24 hours to obtain the lignocellulose;
step 2: synthesizing lignocellulose/MoS₂ composite nanoparticles, specifically comprising: adding a sodium molybdate and a thiourea into deionized water, mixing uniformly to get a uniform and transparent molybdenum precursor solution; adding a lignocellulose into deionized water and stirring uniformly to obtain a lignocellulose aqueous solution, slowly adding the lignocellulose aqueous solution into the molybdenum precursor solution to obtain a first mixed solution, continuously stirring until the first mixed solution becoming sol-emulsion, transferring the first mixed solution to a reactor, carrying out the reaction at a predetermined temperature for a predetermined time to yield a product, and then filtering and washing the product after the reactor is cooled, filtering a black substance from the product, drying the black substance in a vacuum oven to obtain black nanoparticles, gently grinding the black nanoparticles until there is no hard lump to obtain the lignocellulose/MoS₂ composite nanoparticles as solid powder; and
step 3: synthesizing a lignocellulose/MoS₂—Ag nanocomposite to obtain the multifunctional modified molybdenum disulfide nano-additive, specifically comprising: dissolving lignocellulose/MoS₂ composite nanoparticles, a casein hydrolysate and a sodium hydroxide in deionized water with stirring, adding a silver nitrate solution dropwise to obtain a second mixed solution, stirring the second mixed solution at a predetermined temperature for a predetermined time, then mixing with alcohol and centrifuging with high speed to yield a precipitate, lastly, after washing the precipitate and drying under vacuum to obtain the lignocellulose/MoS₂—Ag nanocomposite, namely the multifunctional modified molybdenum disulfide nano-additive.

2. The preparation method for a multifunctional modified molybdenum disulfide nano-additive according to claim 1, characterized in that, the step 2 further comprises:
adding 2 mmol sodium molybdate and 10 mmol thiourea into 40 ml deionized water, ultrasonically mixing uniformly to obtain the uniform, transparent molybdenum precursor solution; adding 0.5 g lignocellulose into 6 ml deionized water, stirring uniformly to obtain the lignocellulose aqueous solution, slowly adding the lignocellulose aqueous solution into the molybdenum precursor solution to obtain the first mixed solution, continuously stirring the first mixed solution until becoming sol-emulsion, transferring the first mixed solution to the stainless steel lined high-temperature and high-pressure double-station parallel reactor, carrying out the reaction at 200° C. for 24 hours to yield the product, and then filtering and washing the product with deionized water and ethanol repeatedly after the reactor is naturally cooled to room temperature, filtering the black substance from the product, drying the black substance in a vacuum oven at 60° C. for 24 hours to obtain black nanoparticles, grinding the black nanoparticles until there is no hard lump to obtain the lignocellulose/MoS₂ composite nanoparticles as solid powder.

3. The preparation method for a multifunctional modified molybdenum disulfide nano-additive according to claim 2, characterized in that, the step 3 further comprises:
dissolving 20 g lignocellulose/MoS₂ nanocomposite particles, 25 mg casein hydrolysate and 10 mg sodium hydroxide in 45 mL, deionized water with vigorous stirring, adding 5 mL silver nitrate solution dropwise to obtain the second mixed solution, magnetically stirring the second mixed solution at 60° C. for 3 h, then mixing with alcohol at 1:4 and centrifuging with high speed at 20000 rmp to yield the precipitate, lastly, after washing the precipitate with deionized water, drying under vacuum to obtain the lignocellulose/MoS₂—Ag nanocomposite, namely the multifunctional modified molybdenum disulfide nano-additive.

4. The preparation method for a multifunctional modified molybdenum disulfide nano-additive according to claim 3, characterized in that, in the step 1.1, the dosage of the BiBB solution is 0.5 mol and the glucopyranose is 162 g/mol.

5. The preparation method for a multifunctional modified molybdenum disulfide nano-additive according to claim 4, characterized in that, the method for degassing the third mixed solution in the step 1.2 is as follows: performing a cyclic degassing of the mixed solution by using a method of a fluid nitrogen cryopreservation, a vacuum-pumping, and a thawing with nitrogen, carrying out the cyclic degassing three times.

6. A multifunctional modified molybdenum disulfide nano-additive, characterized in that, the additive is prepared by using the method according to claim 1.

7. A cutting liquid, characterized in that, the cutting liquid comprises the multifunctional modified molybdenum disulfide nano-additive according to claim 6.

8. A multifunctional modified molybdenum disulfide nano-additive, characterized in that, the additive is prepared by using the method according to claim 2.

9. A cutting liquid, characterized in that, the cutting liquid comprises the multifunctional modified molybdenum disulfide nano-additive according to claim 8.

10. A multifunctional modified molybdenum disulfide nano-additive, characterized in that, the additive is prepared by using the method according to claim 3.

11. A cutting liquid, characterized in that, the cutting liquid comprises the multifunctional modified molybdenum disulfide nano-additive according to claim 10.

12. A multifunctional modified molybdenum disulfide nano-additive, characterized in that, the additive is prepared by using the method according to claim 4.

13. A cutting liquid, characterized in that, the cutting liquid comprises the multifunctional modified molybdenum disulfide nano-additive according to claim 12.

14. A multifunctional modified molybdenum disulfide nano-additive, characterized in that, the additive is prepared by using the method according to claim 5.

15. A cutting liquid, characterized in that, the cutting liquid comprises the multifunctional modified molybdenum disulfide nano-additive according to claim 14.
